(19) United States
(12) Patent Application Publication
(10) Pub. No.: US 2015/0084340 A1
(43) Pub. Date: Mar. 26, 2015

(54) LOAD APPARATUS AND METHOD OF USING SAME

(71) Applicant: TurboGen, LLC, Reno, NV (US)

(72) Inventors: John KUCZAJ, Reno, NV (US); Thomas Cobb BOOTH, Rancho Palos Verdes, CA (US)

(21) Appl. No.: 14/560,178

(22) Filed: Dec. 4, 2014

Related U.S. Application Data
(63) Continuation-in-part of application No. 13/682,313, filed on Nov. 20, 2012, now Pat. No. 8,907,512.

(51) Int. Cl. F02C 6/00; H02K 7/18

(52) U.S. Cl. CPC F02C 6/00; H02K 7/1823
USPC 290/52

(57) ABSTRACT

A load apparatus generally comprises a load that converts mechanical rotational energy to electrical energy. A rotor assembly is coupled to the load and includes a rotor shaft having at least one end portion with at least one extension portion that extends radially outwardly from a surface of the rotor shaft end portion. A coupling shaft couples to the rotor shaft, wherein the coupling shaft includes a cylindrical main body portion. The coupling shaft also includes at least one end portion that extends from the main body portion, wherein the coupling shaft end portion couples to the rotor shaft end portion. The coupling shaft end portion includes an exterior surface, an opposing interior surface, and at least one slot that extends from the interior surface and through the exterior surface, wherein the slot receives the extension portion therein such that the extension portion extends radially outwardly from the exterior surface.

### RELATED AND CO-PENDING APPLICATION

This application is a continuation-in-part of and claims priority to co-pending U.S. patent application Ser. No. 13/682,313 entitled LOAD APPARATUS AND METHOD OF USING SAME filed Nov. 20, 2012, the disclosure of which is incorporated herein by reference in its entirety.

### BACKGROUND

The field of the invention relates generally to power systems and, more particularly, to a load apparatus that may be used in power systems.

At least some known systems, such as power systems, use at least one machine that is coupled to a load. The machine may be a turbine engine that generates torque and also accumulates kinetic mechanical rotational energy in the inertia of a rotating mass. The load may be an electrical system, such as an electrical generator or inverter, which converts the mechanical energy to electrical energy for a power output. The load may also be coupled to an energy storage device such that some of the power output may be stored for later use. For example, at least some known power systems provide bi-directional electrical energy or power flow, wherein the power output from the load may be transferred to the turbine engine to power up the turbine engine or the power output may be delivered to, for example, the energy storage device for storage.

Some power systems that provide bi-directional power flow may use high speed generators to facilitate an increased power density. At least some known high speed generators are mechanically coupled to the turbine engine. More specifically, a rotating element, such as a drive shaft, of the turbine engine may be directly coupled with a rotor shaft of the generator. The drive shaft rotates to enable the turbine engine to generate mechanical rotational energy. As the drive shaft rotates, the generator rotor shaft rotates and the generator is able to convert the mechanical energy to electrical energy. Instead of a direct mechanical connection, there may be intervening elements such as clutches, gear trains, etc.

Because there is no rotor-dynamic isolation between the high speed generator and the turbine engine when there is a mechanical coupling (possibly a direct connection), the inertial state of the drive shaft of the turbine engine may impact that of the rotor shaft of the high speed generator, or vice versa. For example, the high rotational speeds that are implemented may apply centrifugal forces on the drive shaft and/or the rotor shaft that may cause misalignment of the rotor shaft and/or the generator with respect to the drive shaft and/or the turbine engine. Vibrations and imbalances that might be produced by on or the other of the shafts are coupled to both shafts. Such misalignment or the like may lead to a failure of at least one component of the power system, prevent proper bi-directional power flow, and/or adversely affect the overall operation of the power system.

### BRIEF DESCRIPTION

In one embodiment, a load apparatus is provided. The load apparatus may generally comprise a rotating electric machine or similar load that is configured to convert mechanical rotational energy to electrical energy for a power output. A rotor assembly is coupled to the load, wherein the rotor assembly includes a rotor shaft. The rotor shaft includes at least one end portion that includes at least one extension portion that extends radially from a surface of the rotor shaft end portion. A coupling shaft is configured to couple to the rotor shaft, wherein the coupling shaft includes a cylindrical main body portion. The coupling shaft also includes at least one end portion that extends from the main body portion, wherein the coupling shaft end portion is configured to couple to the rotor shaft end portion so as to rotationally fix the coupling shaft to the rotor shaft. The coupling shaft end portion can include an exterior surface, an opposing interior surface, and at least one slot that extends from the interior surface and through the exterior surface, wherein the slot is configured to receive the extension portion therein such that the extension portion extends radially outwardly from the exterior surface.

In another embodiment, a power system is provided. The power system includes a machine that has a rotational drive shaft and a load apparatus that is coupled to the machine. The load apparatus includes a load that is configured to convert mechanical rotational energy to electrical energy for a power output. A rotor assembly is coupled to the load, wherein the rotor assembly includes a rotor shaft. The rotor shaft includes at least one end portion that includes at least one extension portion that extends radially from an axis of the rotor shaft end portion. A coupling shaft is configured to couple to the rotor shaft, wherein the coupling shaft includes a cylindrical main body portion. The coupling shaft also includes at least one end portion that, extends from the main body portion, wherein the coupling shaft end portion is configured to couple to the rotor shaft end portion so as to rotationally fix the two shafts together. The coupling shaft end portion includes an exterior surface, an opposing interior surface, and at least one slot that extends from the interior surface and through the exterior surface, wherein the slot is configured to receive the extension portion of the rotor shaft therein such that the extension portion of the rotor shaft and the surface(s) defining the slot in the coupling shaft bear against one another at least over some span that is radially spaced from the rotational axes of the shafts, which are coaxially aligned, thereby rotationally fixing the shafts together. Although just described as an extension of the rotor shaft received in a slot in the coupling shaft, it should be appreciated that the gender relationship can be reversed and this disclosure encompasses both gender relationships.

In yet another embodiment, a method of using a load apparatus is provided. The method includes providing a load that is configured to convert mechanical rotational energy to electrical energy for a power output. A rotor assembly is coupled to the load, wherein the rotor assembly includes a rotor shaft including at least one end portion. The rotor shaft end portion includes at least one extension portion that extends radially outwardly from a surface of the rotor shaft end portion. A coupling shaft is provided, and the coupling shaft is configured to couple to the rotor shaft, wherein the coupling shaft includes a cylindrical main body portion and at least one end portion that extends from the main body portion. The coupling shaft end portion includes an exterior surface, an opposing interior surface, and at least one slot that extends from the interior surface and through the exterior surface. The coupling shaft end portion is coupled to the rotor shaft end portion such that the slot receives the extension portion therein such that the extension portion extends radially outwardly from the exterior surface.

In another embodiment, a load apparatus is provided and includes a load that is configured to convert mechanical rotational energy to electrical energy for a power output. A rotor assembly is coupled to the load, wherein the rotor assembly includes a rotor shaft that has at least one end portion. The rotor shaft end portion includes at least one extension portion that extends radially outwardly from a surface of the rotor shaft end portion. A coupling shaft is configured to couple to the rotor shaft, wherein the coupling shaft includes a cylindrical main body portion and at least one end portion that extends from the main body portion. The coupling shaft end portion is configured to couple to the rotor shaft end portion. The coupling shaft end portion includes an exterior surface, an opposing interior surface, and at least one slot that extends from the interior surface and to the exterior surface. The slot is configured to receive the extension portion therein such that the extension portion cannot extend through the exterior surface.

In yet another embodiment, a load apparatus generally comprises a first shaft having at least one end portion that includes at least one extension portion that extends radially outwardly from a surface of the end portion. A second shaft is configured to couple to the first shaft, wherein the second shaft includes a cylindrical portion that has at least one end portion. The second shaft end portion is configured to couple to the first shaft end portion, and the second shaft end portion includes an exterior surface, an opposing interior surface, and at least one slot that extends from the interior surface and through the exterior surface, wherein the slot is configured to receive the extension portion therein such that the extension portion extends radially outwardly from the exterior surface.

In another embodiment, a load apparatus generally includes a first shaft having at least one end portion, wherein the first shaft end portion includes at least one extension portion that extends radially outwardly from a surface of the first shaft end portion. A second shaft is configured to couple to the first shaft, wherein the second shaft includes a cylindrical portion that includes at least one end portion, wherein the second shaft end portion is configured to couple to the first shaft end portion. The second shaft end portion includes an exterior surface and an opposing interior surface. At least one slot extends from the interior surface and to the exterior surface, wherein the slot is configured to receive the extension portion therein such that the extension portion cannot extend through the exterior surface.

### BRIEF DESCRIPTION OF THE DRAWINGS

FIG. 1 is a block diagram of an exemplary power system;

FIG. 2 is a partially exploded perspective view of an exemplary load apparatus that may be used with the power system shown in FIG. 1 and taken from area 2;

FIG. 3 is a cross-sectional view of a portion of the load apparatus shown in FIG. 2 and taken along line 3-3;

FIG. 4 is a perspective view of a portion of the load apparatus shown in FIG. 2 and taken from area 4;

FIG. 5 is a block diagram of a portion of the load apparatus shown in FIG. 2 and taken from area 5;

FIG. 6A is a perspective view of a portion of an alternative load apparatus that may be used with the power system shown in FIG. 1 and taken from area 6 (shown in FIG. 2); and

FIG. 6B is a perspective view of a portion of another alternative load apparatus that may be used with the power system shown in FIG. 1 and taken from area 6 (shown in FIG. 2).

### DETAILED DESCRIPTION

The systems, apparatus, and methods described herein provide embodiments of a load apparatus that may be used in a power system, wherein the load apparatus is able to facilitate bi-directional power flow within the power system and the load apparatus is coupled to a machine such that the load apparatus is rotordynamically isolated from the machine. In some embodiments, the load apparatus includes a load and a rotor assembly that is coupled to the load, wherein the rotor assembly includes a rotor shaft that is configured to rotate within at least a portion of the load. The load apparatus also includes the use of a coupling shaft, such as a quill shaft, that is configured to couple the rotor shaft to a drive shaft of the machine such that the rotor shaft is axially and/or radially isolated from the drive shaft to facilitate rotordynamic isolation between the load apparatus and the machine. Moreover, as described herein, the machining of various components of the load apparatus is cost effective.

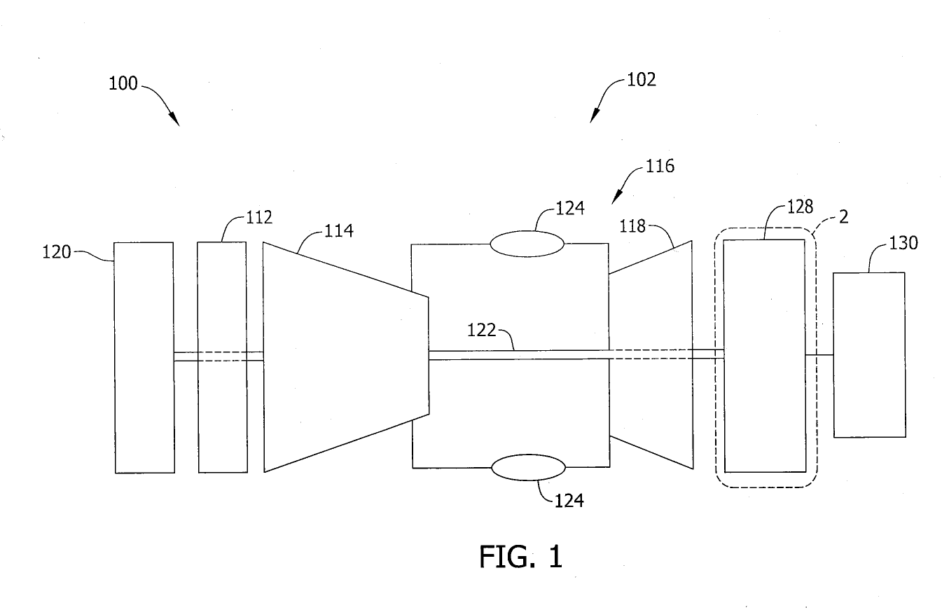

FIG. 1 illustrates one embodiment of a power system 100. It should be noted that the present disclosure is not limited to power systems, and one of ordinary skill in the art will appreciate that the current disclosure may be used in connection with any type of system. In some embodiments, power system 100 includes a machine, such as a gas turbine engine 102. The present disclosure is not limited to any one particular type of machine, and one of ordinary skill in the art will appreciate that the current disclosure may be used in connection with other types of machines. For example, machine may be a compressor, a pump, a turbocharger, and/or various types of turbines.

Moreover, in some embodiments, turbine engine 102 includes an intake section 112, a compressor section 114 coupled downstream from the intake section 112, a combustor section 116 coupled downstream from the compressor section 114, a turbine section 118 coupled downstream from the combustor section 116, and an exhaust section 120. It should be noted that, as used herein, the term “couple” is not limited to a direct mechanical, thermal, communication, and/or an electrical connection between components, but may also include an indirect mechanical, thermal, communication and/or electrical connection between multiple components.

Turbine section 118, in the some embodiments, is coupled to compressor section 114 via a drive shaft 122. Combustor section 116 includes a plurality of combustors 124 and is coupled to compressor section 114 such that each combustor 124 is positioned in flow communication with compressor section 114. Turbine section 118 is coupled to compressor section 114 and to a load apparatus 128 via the drive shaft 122. In some embodiments, load apparatus 128 includes a load (not shown in FIG. 1) that is an electrical system, such as a high speed electrical generator or inverter. Load apparatus 128 is coupled to an energy storage device 130, such as a battery. In some embodiments, compressor section 114 and turbine section 118 includes at least one rotor disk assembly (not shown) that is coupled to drive shaft 122.

During operation, intake section 112 channels air towards compressor section 114 wherein the air is compressed to a higher pressure and temperature prior to being discharged towards combustor section 116. The compressed air is mixed with fuel and other fluids and ignited to generate combustion gases that are channeled towards turbine section 118. More specifically, fuel, such as natural gas and/or fuel oil, air, diluents, and/or Nitrogen gas (N₂), is injected into combustors 124, and into the air flow. The blended mixtures are ignited to generate high temperature combustion gases that expand as they are channeled towards turbine section 118. Turbine section 118 converts the thermal energy from the gas stream to mechanical rotational energy, as the combustion gases impart rotational energy to turbine section 118 and to the rotor disk assembly.

The mechanical rotational energy is converted to electrical energy via load apparatus 128 for a power output. As explained in more detail below, load apparatus 128 facilitates bi-directional power flow within power system 100 such that the power output from load apparatus 128 may be transferred to turbine engine 102 to power the turbine engine 102 or the power output may be delivered to, for example, energy storage device 130.

In some embodiments, the mechanical rotational energy that is generated by turbine section 118 is enabled by the rotation of drive shaft 122. As drive shaft 122 rotates, at least a portion of load apparatus 128 rotates. For example, a rotor shaft (not shown in FIG. 1) of load apparatus 128 rotates. Due to the high rotational speeds implemented by drive shaft 122 and/or the rotor shaft, mechanical stress may be endured by each. The mechanical stress may cause misalignment of the rotor shaft and/or load apparatus 128 with respect to drive shaft 122 and/or turbine engine 102. However, as described in more detail below, load apparatus 128 is rotordynamically isolated from turbine engine 102. Accordingly, mechanical stress and/or misalignment of the rotor shaft and/or load apparatus 128 with respect to drive shaft 122 and/or turbine engine 102 may be inhibited.

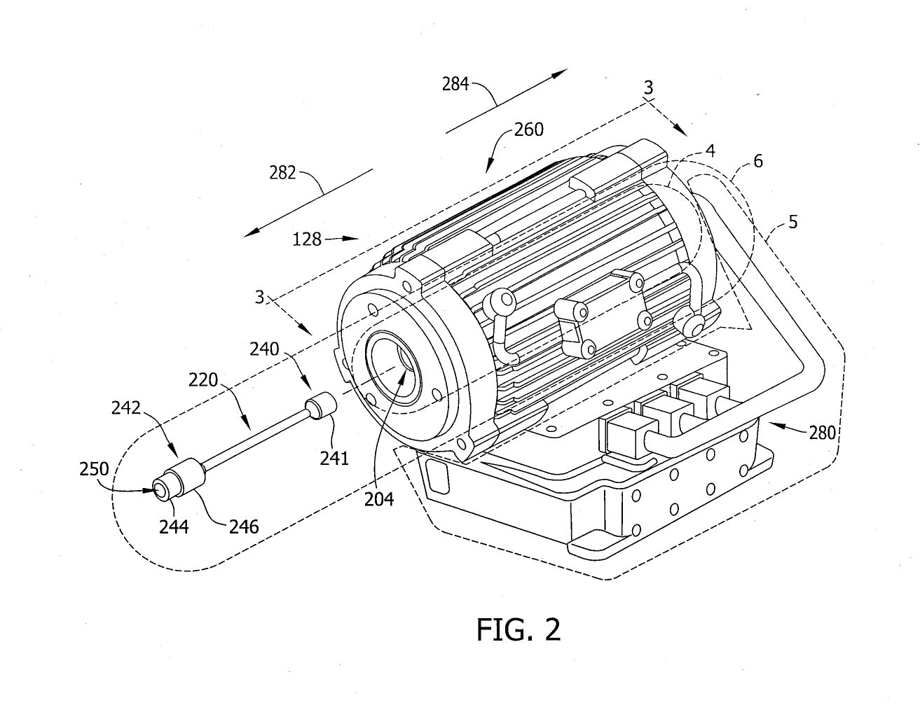

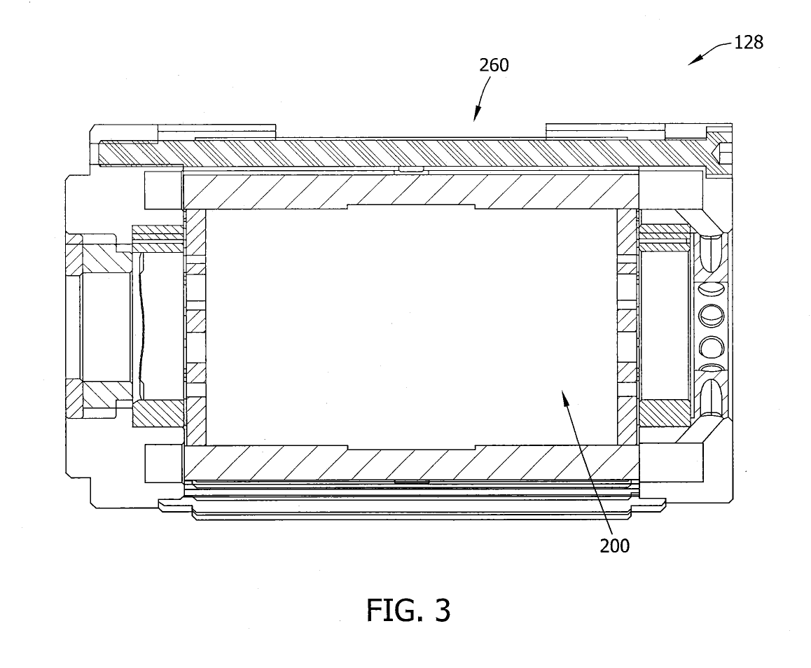

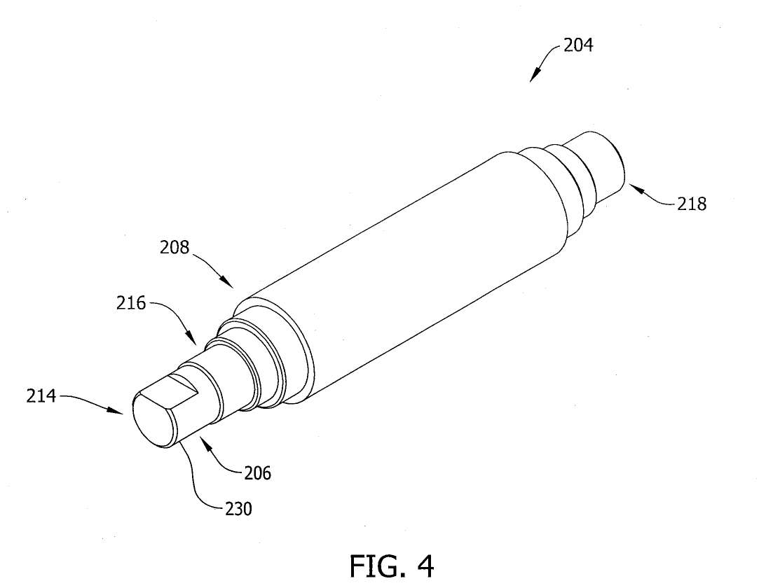

FIG. 2 is a partially exploded perspective view of load apparatus 128 taken from area 2 (shown in FIG. 1). FIG. 3 is a cross-sectional view of a portion of load apparatus 128 taken along line 3-3 (shown in FIG. 2). FIG. 4 is a perspective view of a portion of load apparatus 128 taken from area 4 (shown in FIG. 2). Referring to FIGS. 2 and 3, load apparatus 128 includes a load 200 that is a high speed generator configured to convert mechanical rotational energy to electrical energy for a power output. Alternatively, load 200 may be any suitable type of device or system that is configured to generate electrical energy that enables load apparatus 128 and/or power system 100 (shown in FIG. 1) to function as described herein.

Referring to FIGS. 3 and 4, a rotor assembly 204 is coupled to load 200 such that at least a portion of load 200 substantially circumscribes at least a portion of rotor assembly 204. In some embodiments, rotor assembly 204 is the rotor assembly described in co-pending U.S. patent application Ser. No. 13/682,378 entitled ROTOR ASSEMBLY AND METHOD OF USING SAME filed Nov. 20, 2012, which is incorporated herein by reference in its entirety. Rotor assembly 204 includes a substantially cylindrical rotor shaft 206 that is coupled to a sleeve apparatus 208 such that at least a portion of rotor shaft 206 is positioned within sleeve apparatus 208 (FIG. 4). In some embodiments, rotor shaft 206 includes a first end portion 214, a middle portion 216, and a second end portion 218. Rotor shaft 206 is positioned within sleeve apparatus 208 such that at least a portion of middle portion 216 is positioned within sleeve apparatus 208, and first end portion 214 and second end portion 218 are not positioned within sleeve apparatus 208. As such, rotor shaft 206 is configured to rotate within at least a portion of load 200.

In some embodiments, second end portion 218 of rotor shaft 206 has a diameter that is substantially equal to the diameter of middle portion 216. Referring to FIGS. 2 and 4, first end portion 214 is configured to be removably coupled to a coupling shaft, such as a quill shaft 220. More specifically, in some embodiments, first end portion 214 includes a first surface 230 that is substantially arcuate and a second surface 232 that is substantially planar such that the first end portion is positionable within an opening (not shown) on a first end portion 240 of quill shaft 120. For example, the opening on first end portion 240 of quill shaft 120 is configured to receive first end portion 214 of rotor shaft 206. Moreover, first end portion 240 of quill shaft 120 includes a splined engagement member 241 to facilitate the coupling between first end portion 240 of quill shaft 120 and first end portion 214 of rotor shaft 206.

Quill shaft 220, in some embodiments, is configured to couple rotor shaft 206 to drive shaft 122 (shown in FIG. 1). For example, while first end portion 240 of quill shaft 220 is configured to couple to a first end portion 214 of rotor shaft 217, a second end portion 242 of quill shaft 220 is configured to couple to an end portion (not shown) of drive shaft 122. In some embodiments, second end portion 242 of quill shaft 220 includes a substantially cylindrical interior portion 244 and a substantially cylindrical exterior portion 246 that substantially circumscribes at least a portion of interior portion 244. An opening 250 is defined within interior portion 244 such that an end portion of drive shaft 122 is positionable within opening 250. Accordingly, rotor shaft 206 is coupled to drive shaft 122 via quill shaft 220 such that rotor shaft 206 is axially and/or radially isolated from drive shaft 122 to facilitate rotordynamic isolation between load apparatus 128 and turbine engine 102 (shown in FIG. 1). In some embodiments, quill shaft 220 is configured to facilitate axial freedom of movement that enables drive shaft 122 to float axially and independently of the axial movement of rotor shaft 206.

Referring to FIGS. 2 and 3, load apparatus 128 includes a housing apparatus 260 that is coupled to load 200 and to rotor assembly 204 such that housing apparatus 260 substantially encloses at least a portion of load 200 and at least a portion of rotor assembly 204 therein. In some embodiments, housing apparatus 260 is the housing apparatus described in U.S. Pat. No. 8,796,875 entitled HOUSING APPARATUS AND METHOD OF USING SAME issued on Aug. 5, 2014, which is incorporated herein by reference in its entirety.

Referring to FIG. 2, in some embodiments, load apparatus 128 also includes a control system 280 that is coupled to load 200, wherein control system 280 is configured to control the power output produced by load 128. For example, control system 280 is configured to control channeling torque produced by load 200 in a first direction 282 towards turbine engine 102 such that the power output may be used by turbine engine 102 or in a second direction 284 toward energy storage device 130 such that the power output may be stored for later use by the power system 100.

During operation, referring to FIGS. 2, 3, and 4, turbine section 118 (shown in FIG. 1) converts the thermal energy from the gas stream to mechanical rotational energy, as the combustion gases impart rotational energy to turbine section 118 and to a rotor disk assembly (not shown). The mechanical rotational energy is then converted to electrical energy via load 200. In some embodiments, the mechanical rotational energy that is generated by turbine section 118 is enabled by the rotation of drive shaft 122. As drive shaft 122 rotates, rotor assembly 204 rotates. For example, rotor shaft 206 of rotor assembly 204 rotates. Due to the high rotational speeds implemented by drive shaft 122 and/or rotor shaft 206, drive shaft 122 and/or rotor shaft 206 may undergo mechanical stress that results in a misalignment of rotor shaft 206, rotor assembly 204, and/or load 200 with respect to drive shaft 122 and/or turbine engine 102.

However, because rotor shaft 206 is coupled to drive shaft 122 via quill shaft 220, rotor shaft 206 is axially and/or radially isolated from drive shaft 122. As such, there is rotordynamic isolation between load apparatus 128 and turbine engine 102. As a result, impact to rotor shaft 206 from rotational deviations that drive shaft 122 may endure is inhibited. Similarly, impact on drive shaft 122 from rotational deviations that rotor shaft 206 may endure is inhibited. Accordingly, mechanical stress, wear and/or misalignment of rotor shaft 206 and/or load apparatus 128 with respect to drive shaft 122 and/or turbine engine 102 may be prevented.

Moreover, load apparatus 128 is configured to thermally isolate turbine engine 102 from load apparatus 128. As such, heat that is dissipating from turbine engine 102 does not substantially impact load apparatus 128. Accordingly, the potentially negative performance effects of the thermally limited components of turbine engine 102 and/or load apparatus 128 are substantially reduced. Load apparatus 128 is also configured to substantially reduce the available heat transfer area to propagate heat conductivity to turbine engine 102, and provide flexibility with cooling options that can be applied to, for example, attachment components.

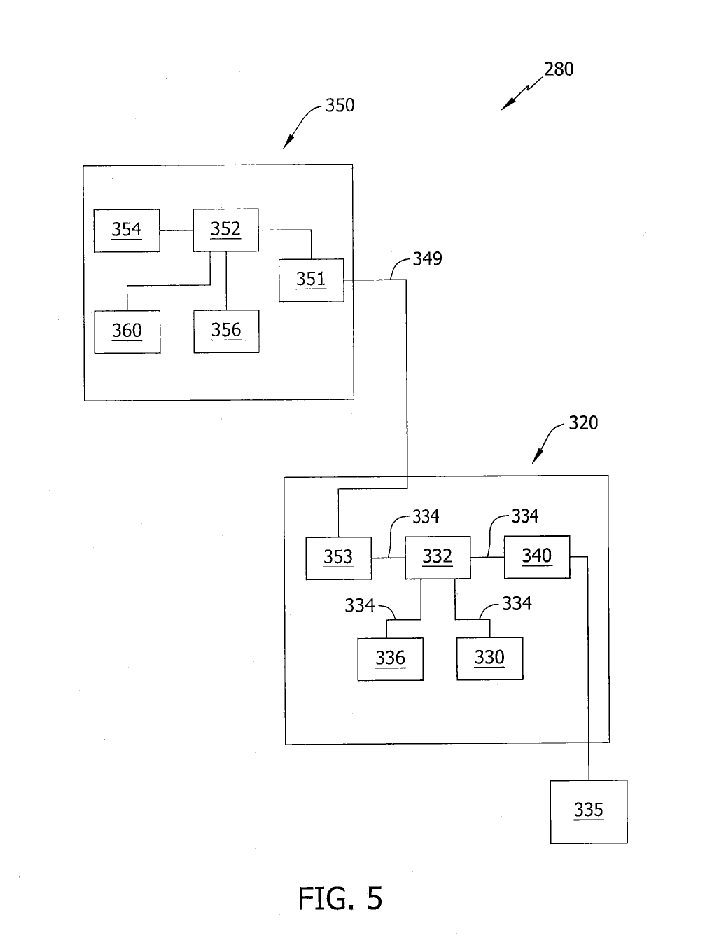

FIG. 5 is a block diagram of control system 280 taken from area 5 (shown in FIG. 2). In some embodiments, control system 280 includes a controller 320 that is operatively coupled to load 200 (shown in FIG. 3). For example, controller 320 may be coupled to at least one control valve or switch (not shown). In some embodiments, controller 320 is configured to control the valve or switch to control the power output being channeled in either first direction 282 (shown in FIG. 2) or second direction 284 (shown in FIG. 2). Controller 320 is also configured to change the power output flow from first direction 282 to second direction 284 and/or from second direction 284 to first direction 282. Controller 320 is enabled to facilitate operative features of the valve or switch, via features that include, without limitation, receiving permissive inputs, transmitting permissive outputs, and transmitting opening and closing commands.

In some embodiments, controller 320 may be a real-time controller and may include any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, controller 320 may be a microprocessor that includes read-only memory (ROM) and/or random access memory (RAM), such as, for example, a 32 bit microcomputer with 2 Mbit ROM and 64 Kbit RAM. As used herein, the term “real-time” refers to outcomes occurring in a substantially short period of time after a change in the inputs affect the outcome, with the time period being a design parameter that may be selected based on the importance of the outcome and/or the capability of the system processing the inputs to generate the outcome.

In some embodiments, controller 320 includes a memory device 330 that stores executable instructions and/or one or more operating parameters representing and/or indicating an operating condition of load apparatus 128 and/or power system 100 (shown in FIG. 1). In some embodiments, controller 320 also includes a processor 332 that is coupled to memory device 330 via a system bus 334. In one embodiment, processor 332 may include a processing unit, such as, without limitation, an integrated circuit (IC), an application specific integrated circuit (ASIC), a microcomputer, a programmable logic controller (PLC), and/or any other programmable circuit. Alternatively, processor 332 may include multiple processing units (e.g., in a multi-core configuration). The above examples are exemplary only, and thus are not intended to limit in any way the definition and/or meaning of the term “processor.”

Moreover, in some embodiments, controller 320 includes a control interface 336 that is coupled to the valve or switch and that is configured to control an operation of the valve or switch. For example, processor 332 may be programmed to generate one or more control parameters that are transmitted to control interface 336. Control interface 336 may then transmit a control parameter to modulate, open, or close the valve or switch.

Various connections are available between control interface 336 and the valve or switch. Such connections may include, without limitation, an electrical conductor, a low-level serial data connection, such as Recommended Standard (RS) 232 or RS-485, a high-level serial data connection, such as USB, a field bus, a PROFIBUS®, or Institute of Electrical and Electronics Engineers (IEEE) 1394 (a/k/a FIREWIRE), a parallel data connection, such as IEEE 1284 or IEEE 488, a short-range wireless communication channel such as BLUETOOTH, and/or a private (e.g., inaccessible outside power system 100) network connection, whether wired or wireless. IEEE is a registered trademark of the Institute of Electrical and Electronics Engineers, Inc., of New York, N.Y. BLUETOOTH is a registered trademark of Bluetooth SIG, Inc. of Kirkland, Wash. PROFIBUS is a registered trademark of Profibus Trade Organization of Scottsdale, Ariz.

In some embodiments, control system 280 includes at least one sensor 335 that is coupled to load 200 and to controller 320. In some embodiments, controller 320 includes a sensor interface 340 that is coupled to sensor 335. In some embodiments, sensor 335 is positioned in close proximity to, and coupled to at least a portion of load 200. Alternatively, sensor 335 may be coupled to various other components within power system 100. In some embodiments, sensor 335 is configured to detect the level of the power output being produced by load 200. Alternatively, sensor 335 may detect various other operating parameters that enable load apparatus 128 and/or power system 100 to function as described herein.

Sensor 335 transmits a signal corresponding to a power output detected for load 200 to controller 320. Sensor 335 may transmit a signal continuously, periodically, or only once, for example. Other signal timings may also be contemplated. Furthermore, sensor 335 may transmit a signal either in an analog form or in a digital form. Various connections are available between sensor interface 340 and sensor 335. Such connections may include, without limitation, an electrical conductor, a low-level serial data connection, such as RS 232 or RS-485, a high-level serial data connection, such as USB or IEEE® 1394, a parallel data connection, such as IEEE® 1284 or IEEE® 488, a short-range wireless communication channel such as BLUETOOTH®, and/or a private (e.g., inaccessible outside power system 100) network connection, whether wired or wireless.

Control system 280 may also include a user computing device 350 that is coupled to controller 320 via a network 349. User computing device 350 includes a communication interface 351 that is coupled to a communication interface 353 contained within controller 320. User computing device 350 includes a processor 352 for executing instructions. In some embodiments, executable instructions are stored in a memory device 354. Processor 352 may include one or more processing units (e.g., in a multi-core configuration). Memory device 354 is any device allowing information, such as executable instructions and/or other data, to be stored and retrieved.

User computing device 350 also includes at least one media output component 356 for use in presenting information to a user. Media output component 356 is any component capable of conveying information to the user. Media output component 356 may include, without limitation, a display device (not shown) (e.g., a liquid crystal display (LCD), an organic light emitting diode (OLED) display, or an audio output device (e.g., a speaker or headphones)).

In some embodiments, user computing device 350 includes an input interface 360 for receiving input from the user. Input interface 360 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of media output component 356 and input interface 360.

During operation, a user may initially input a predefined threshold value for a power output from load 200 via input interface 360. The predefined threshold value may be programmed with user computing device 350 and/or the controller 320. When turbine engine 102 (shown in FIG. 1) commences operation, mechanical rotational energy is generated. When the mechanical rotational energy is converted to electrical energy via load 200 for a power output, the output is detected by sensor 335. Sensor 335 then transmits a signal representative of the power output to controller 320.

Depending on whether the power output is less than, greater than, or equal to the predefined threshold, controller 320 will transmit a control parameter to the valve or switch. For example, in some embodiments, if the power output exceeds the predefined threshold, controller 320 will transmit a control parameter to the valve or switch such that electrical energy (i.e. power output) is channeled in second direction 284 towards energy storage device 130 such that the power output may be stored for later use by power system 100. If the power output is below the predefined threshold, controller 320 may transmit a control parameter to the valve or switch such that electrical energy is channeled in first direction 282 towards turbine engine 102 such that the power output may be used by turbine engine 102 to generate additional power.

Due to the bi-directional capabilities of power system 100, the high rotational speeds implemented by drive shaft 122 (shown in FIG. 1) and/or rotor shaft 206 (shown in FIG. 4) may vary or cause deviations. Such rotational variations and/or deviations may cause rotor shaft 206 and/or drive shaft 122 to undergo mechanical stress that results in a misalignment of rotor shaft 206, rotor assembly 204 (shown in FIGS. 2 and 4), and/or load 200 with respect to drive shaft 122 and/or turbine engine 102. However, because rotor shaft 206 is coupled to drive shaft 122 via quill shaft 220 (shown in FIG. 2), rotor shaft 206 is axially and/or radially isolated from drive shaft 122. As such, there is rotordynamic isolation between load apparatus 128 and turbine engine 102. Accordingly, mechanical stress and/or misalignment of rotor shaft 206 and/or load apparatus 128 with respect to drive shaft 122 and/or turbine engine 102 may be inhibited even when there is bi-directional power flow within power system 100.

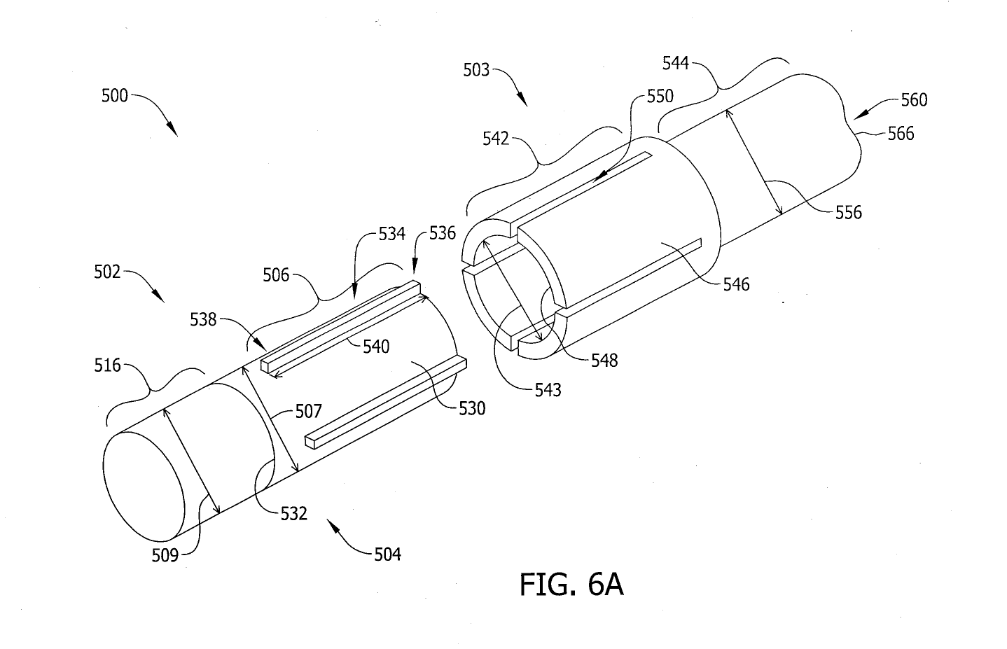

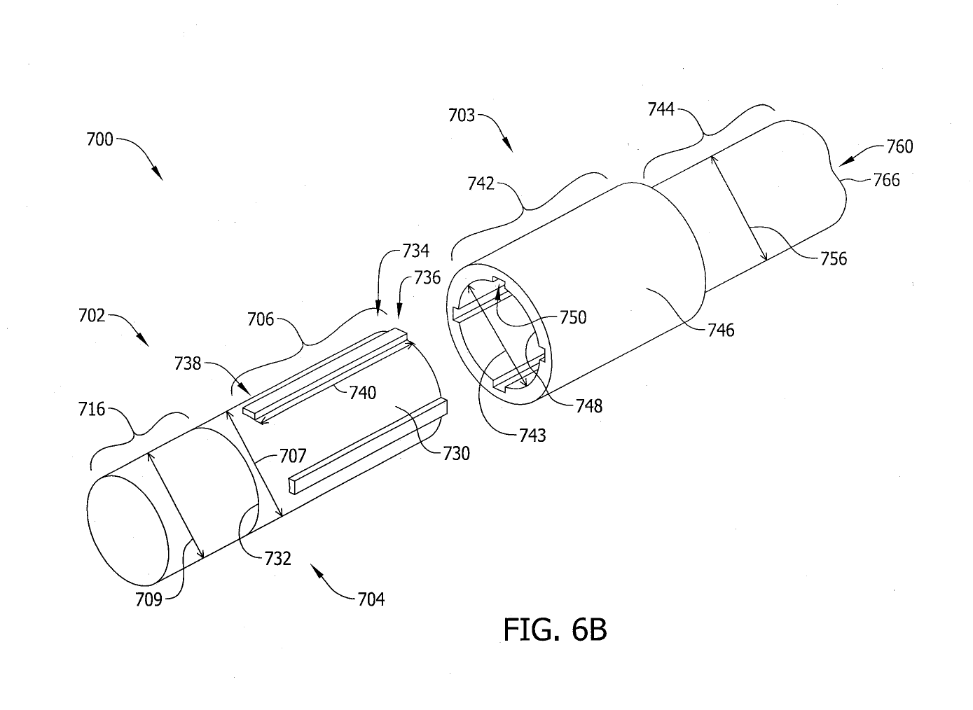

FIG. 6A illustrates a portion of an alternative load apparatus 500 that can be used in place of load apparatus 128 (shown, in FIGS. 1-5) and taken from area 6 (shown in FIG. 2). For example, FIG. 6A illustrates a portion of a rotor assembly 502 that may be used in place of rotor assembly 204 (shown in FIGS. 2 and 4) and a portion of a coupling or quill shaft 503 that may be used in place of quill shaft 220 (shown in FIG. 2).

Rotor assembly 502 includes a substantially cylindrical rotor shaft 504, wherein at least a portion of shaft 504 can be positioned within a sleeve apparatus, such as sleeve apparatus 208 (shown in FIG. 4). In some embodiments, rotor shaft 504 includes a first end portion 506, a main body portion or middle portion 516, and a second end portion (not shown). Rotor shaft 504 can be positioned within sleeve apparatus 208 such that at least a portion of middle portion 516 is positioned within sleeve apparatus 208, and first end portion 506 and the second end portion are not positioned within sleeve apparatus 208. As such, rotor shaft 504 is configured to rotate within at least a portion of load 200 (shown in FIG. 3).

In some embodiments, first end portion 506 of rotor shaft 504 has a diameter 507 that is substantially equal to the diameter 509 of middle portion 516. Alternatively, first end portion 506 and middle portion 516 may each have diameters that are different from each other. First end portion 506 is configured to be removably coupled to quill shaft 503. For example, in some embodiments, first end portion 506 includes an exterior surface 530 and opposing interior surface 532. At least one extension portion, such as extension portions 534, extend radially outwardly from exterior surface 530. In some embodiments, extension portions 534 are each substantially rectangular. Alternatively, extension portions 534 can have any suitable shape that enables load apparatus 500 and/or power system 100 (shown in FIG. 1) to function as described herein. Each extension portion 534 has a first end portion 536 and a second end portion 538 a predefined distance 540 from first end portion 536, wherein distance 540 can be any suitable distance that enables load apparatus 500 and/or power system 100 to function as described herein. Extension portions 534 can be machined onto exterior surface 530, via any processes and techniques known in the art, such that extension portions 534 are integrally formed with exterior surface 530. In some embodiments, the second end portion of rotor shaft 504 can be identical in shape and structure as first end portion 506 of rotor shaft 504. Alternatively, the second end portion of rotor shaft 504 can have a shape and structure that varies from first end portion 506 of rotor shaft 504.

In some embodiments, first end portion 506 (including extension portions 534), middle portion 516, and the second end portion or rotor shaft 504 are each formed of the same suitable material, such as the same type of metal material, and can be machined and integrally formed together, via any processes or techniques known in the art, such that rotor shaft 504 is a unitary component. Alternatively, first end portion 506 (including extension portions 534), middle portion 516, and the second end portion can each be formed of the same suitable material or different suitable materials, such as different types of metals, and can be removably coupled to each other such that rotor shaft 504 is not a unitary component.

Quill shaft 503, in some embodiments, is substantially cylindrical and also includes a first end portion 542, a main body portion or middle portion 544, and a second end portion (not shown). First end portion 542 of quill shaft 503 is configured to receive first end portion 506 of rotor shaft 504. For example, first end portion 542 of quill shaft 503 includes an exterior surface 546 and an opposing interior surface 548. At least one slot, such as slots 550, extends from interior surface 548 and through exterior surface 546 and each slot 550 is configured to receive one corresponding extension portion 534 from rotor shaft 504 therein. First end portion 542 of quill shaft 503 has a diameter 543 that is greater than diameter 507 of first end portion 506 of rotor shaft 504 such that at least a portion of first end portion 506 of rotor shaft can be positioned within first end portion 542 of quill shaft 503. When first end portion 506 of rotor shaft 504 is positioned within first end portion 542 of quill shaft 503, then each extension portion 534 is positioned within a corresponding slot 550 such that each extension portion 534 extends radially outwardly from exterior surface 546 of quill shaft 503.

In some embodiments, first end portion 542, middle portion 544, and the second end portion of quill shaft 503 are each formed of the same suitable material, such as the same type of metal, and can be machined and integrally formed together, via any processes known in the art, such that quill shaft 503 is unitary component. Alternatively, first end portion 542, middle portion 544, and the second end portion can each be formed of the same suitable material or different suitable materials, such as different types of metals, and can be removably coupled to each other such that quill shaft 503 is not a unitary component.

In some embodiments, diameter 543 of first end portion 542 is not equal to a diameter 556 of middle portion 544 of quill shaft 503. Alternatively, diameter 543 of first end portion 542 is equal to diameter 556 of middle portion 544. In some embodiments, middle portion 544 has a channel 560 defined therein such that middle portion 544 is substantially hollow. In other embodiments, middle portion 544 does not have a channel therein such that an interior portion 566 of middle portion 544 is substantially solid.

The second portion of quill shaft 503, in some embodiments, is identical in shape and structure as first end portion 542 of quill shaft 503 and an end portion (not shown) of drive shaft 122 (shown in FIG. 1) is identical to the shape and structure of first end portion 506 of rotor shaft 504 such that the second end portion of quill shaft 503 can couple to the end portion of drive shaft 122 in the same manner that first end portion 542 of quill shaft 503 couples to first end portion 506 of rotor shaft 504.

The number of extension portions 534 from first end portion 506 of rotor shaft 504 and the number of slots 550 from first end portion 542 of quill shaft 503 can vary to any suitable number that enables load apparatus 500 and/or power system 100 to function as described herein so long as the number of extension portions 534 equals the number of slots 550. For example, in some embodiments, first end portion 506 of rotor shaft 504 can have two extension portions 534 that are located 180 degrees apart from each other on exterior surface 530 of first end portion 506. Similarly, first end portion 542 of quill shaft 503 can have two slots 550 that are located 180 degrees apart from each other such that each of the two slots 550 are configured to receive the corresponding extension portion 534 therein.

The use of extension portions 534 being positioned within corresponding slots 550 enables torque to be transmitted though quill shaft 503 to mitigate misalignment issues between rotor shaft 504 and drive shaft 122. Moreover, when there are two extension portions 534 being used that are 180 degrees apart and two corresponding slots 550, the torque transmitted is aligned with the central axis of quill shaft 503. Moreover, having a hollow middle portion 544 for quill shaft 503 can be relatively lower in cost in that first end portion 542 and the second end portion of quill shaft 503 integrates with middle portion 544. Having a hollow middle portion 544 offers the further benefit of not requiring any machining other than slots 550 so that the dimensions of middle portion 544 can be controlled precisely during manufacturing and trim balancing of quill shaft 503 can be minimized.

In some embodiments, the end portions, such as first end portion 542, of quill shaft 503 and the end portions, such as first end portion 506, of rotor shaft 504 can have their relationships reversed. For example, first end portion 506 of rotor shaft 504 can have the shape and structures of first end portion 542 of quill shaft 503 and vice versa to facilitate the coupling relationship as described above.

FIG. 6B illustrates a portion of an alternative load apparatus 700 that can be used in place of load apparatus 128 (shown in FIGS. 1-5) and taken from area 6 (shown in FIG. 2). For example, FIG. 6B illustrates a portion of a rotor assembly 702 that may be used in place of rotor assembly 204 (shown in FIGS. 2 and 4) and a portion of a coupling or quill shaft 703 that may be used in place of quill shaft 220 (shown in FIG. 2).

Rotor assembly 702 includes a substantially cylindrical rotor shaft 704, wherein at least a portion of shaft 704 can be positioned within a sleeve apparatus, such as sleeve apparatus 208 (shown in FIG. 4). In some embodiments, rotor shaft 704 includes a first end portion 706, a main body portion or middle portion 716, and a second end portion (not shown). Rotor shaft 704 can be positioned within sleeve apparatus 208 such that at least a portion of middle portion 716 is positioned within sleeve apparatus 208, and first end portion 706 and the second end portion are not positioned within sleeve apparatus 208. As such, rotor shaft 704 is configured to rotate within at least a portion of load 200 (shown in FIG. 3).

In some embodiments, first end portion 706 of rotor shaft 704 has a diameter 707 that is substantially equal to the diameter 709 of middle portion 716. Alternatively, first end portion 706 and middle portion 716 may each have diameters that are different from each other. First end portion 706 is configured to be removably coupled to quill shaft 703. For example, in some embodiments, first end portion 706 includes an exterior surface 730 and opposing interior surface 732. At least one extension portion, such as extension portions 734, extends radially outwardly from exterior surface 730. In some embodiments, extension portions 734 are each substantially rectangular. Alternatively, extension portions 734 can have any suitable shape that enables load apparatus 700 and/or power system 100 (shown in FIG. 1) to function as described herein. Each extension portion 734 has a first end portion 736 and a second end portion 738 a predefined distance 740 from first end portion 736, wherein distance 740 can be any suitable distance that enables load apparatus and/or power system 100 to function as described herein. Extension portions 734 can be machined onto exterior surface 730, via any processes and techniques known in the art, such that extension portions 734 are integrally formed with exterior surface. In some embodiments, the second end portion of rotor shaft 704 can be identical in shape and structure as first end portion 706 of rotor shaft 704. Alternatively, the second end portion of rotor shaft 704 can have a shape and structure that varies from first end portion 706 of rotor shaft 704.

In some embodiments, first end portion 706 (including extension portions 734), middle portion 716, and the second end portion or rotor shaft 704 are each formed of the same suitable material, such as the same type of metal material, and can be machined and integrally formed together, via any processes or techniques known in the art, such that rotor shaft 704 is a unitary component. Alternatively, first end portion 706 (including extension portions 734), middle portion 716, and the second end portion can each be formed of the same suitable material or different suitable materials, such as different types of metals, and can be removably coupled to each other such that rotor shaft 704 is not a unitary component.

Quill shaft 703, in some embodiments, is substantially cylindrical and also includes a first end portion 742, a main body portion or middle portion 744, and a second end portion (not shown). First end portion 742 of quill shaft 703 is configured to receive first end portion 706 of rotor shaft 704. For example, first end portion 742 of quill shaft 703 includes an exterior surface 746 and an opposing interior surface 748. At least one slot, such as slots 750 extend from interior surface 748 and to exterior surface 746 such that each slot 750 does not extend through exterior surface 746 and is not visible from exterior surface 746.

Each slot 750 is configured to receive one corresponding extension portion 734 from rotor shaft 704 therein. First end portion 742 of quill shaft 703 has a diameter 743 that is greater than diameter 707 of first end portion 706 of rotor shaft 704 such that first end portion 706 of rotor shaft can be positioned within first end portion 742 of quill shaft 703. When first end portion 706 of rotor shaft 704 is positioned within first end portion 742 of quill shaft 703, then each extension portion 734 is positioned within a corresponding slot 750 such that each extension portion 734 cannot extend through exterior surface 746 of quill shaft 703.

In some embodiments, first end portion 742, middle portion 744, and the second end portion of quill shaft 703 are each formed of the same suitable material, such as the same type of metal, and can be machined and integrally formed together, via any processes known in the art, such that quill shaft 703 is a unitary component. Alternatively, first end portion 742, middle portion 744, and the second end portion can each be formed of the same suitable material or different suitable materials, such as different types of metals, and can be removably coupled to each other such that quill shaft 703 is not a unitary component.

In some embodiments, diameter 743 of first end portion 742 is not equal to a diameter 756 of middle portion 744 of quill shaft 703. Alternatively, diameter 743 of first end portion 742 is equal to diameter 756 of middle portion 744. In some embodiments, middle portion 744 has a channel 760 defined therein such that middle portion 744 is substantially hollow. In other embodiments, middle portion 744 does not have a channel therein such that an interior portion 766 of middle portion 744 is substantially solid.

The second portion of quill shaft 703, in some embodiments, is identical in shape and structure as first end portion 742 of quill shaft 703 and an end portion (not shown) of drive shaft 122 (shown in FIG. 1) is identical to the shape and structure of first end portion 706 of rotor shaft 704 such that the second end portion of quill shaft 703 can couple to the end portion of drive shaft 122 in the same manner that first end portion 742 of quill shaft 703 couples to first end portion 706 of rotor shaft 704.

The number of extension portions 734 from first end portion 706 of rotor shaft 704 and the number of slots 750 from first end portion 742 of quill shaft 703 can vary to any suitable number that enables load apparatus 700 and/or power system 100 to function as described herein so long as the number of extension portions 734 equals the number of slots 750. For example, in some embodiments, first end portion 706 of rotor shaft 704 can have two extension portions 734 that are located 180 degrees apart from each other on exterior surface 730 of first end portion 706. Similarly, first end portion 742 of quill shaft 703 can have two slots 750 that are located 180 degrees apart from each other such that each of the two slots 750 are configured to receive the corresponding extension portion 734 therein.

The use of extension portions 734 being positioned within slots 750 enables torque to be transmitted though quill shaft 703 to mitigate misalignment issues between rotor shaft 704 and drive shaft 122. Moreover, when there are two extension portions 734 being used that are 180 degrees apart and two corresponding slots 750, the torque transmitted is aligned with the central axis of quill shaft 703. Moreover, having a hollow middle portion 744 for quill shaft 703 can be relatively lower in cost in that first end portion 742 and the second end portion of quill shaft 703 integrates with middle portion 744. Having a hollow middle portion 744 offers the further benefit of not requiring any machining other than slots 750 so that the dimensions of middle portion 744 can be controlled precisely during manufacturing and trim balancing of quill shaft 703 can be minimized.

In some embodiments, the end portions, such as first end portion 742, of quill shaft 703 and the end portions, such as first end portion 706, of rotor shaft 704 can have their relationships reversed. For example, first end portion 706 of rotor shaft 704 can have the shape and structures of first end portion 742 of quill shaft 703 and vice versa to facilitate the coupling relationship as described above.

As compared to known power systems that provide bi-directional power flow, the embodiments of a power system described herein include embodiments of a load apparatus that is able to facilitate bi-directional power flow within the power system and the load apparatus is coupled to a machine such that the load apparatus is rotordynamically isolated from the machine. In some embodiments, the load apparatus includes a load and a rotor assembly that is coupled to the load, wherein the rotor assembly includes a rotor shaft that is configured to rotate within at least a portion of the load. The load apparatus also includes the use of a coupling shaft, such as a quill shaft, that is configured to couple the rotor shaft to a drive shaft of the machine such that the rotor shaft is axially and/or radially isolated from the drive shaft to facilitate rotordynamic isolation between the load apparatus and the machine. Moreover, as described herein, the machining of various components of the load apparatus is cost effective.

Exemplary embodiments of systems, apparatus, and methods are described above in detail. The systems, apparatus, and methods are not limited to the specific embodiments described herein, but rather, components of each system, apparatus, and/or method may be utilized independently and separately from other components described herein. For example, each system may also be used in combination with other systems and is not limited to practice with only systems as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A load apparatus comprising:
a load configured to convert mechanical rotational energy to electrical energy for a power output;
a rotor assembly coupled to said load, wherein said rotor assembly comprises a rotor shaft comprising at least one rotor shaft end portion, said at least one rotor shaft end portion comprises at least one extension portion that extends radially outwardly from a surface of said at least one rotor shaft end portion; and
a coupling shaft configured to couple to said rotor shaft, wherein said coupling shaft comprises:
a cylindrical main body portion; and
at least one cylindrical coupling shaft end portion that extends from said main body portion, wherein said at least one coupling shaft end portion is configured to couple to said at least one rotor shaft end portion, said at least one coupling shaft end portion comprises:
an exterior surface;
an opposing interior surface; and
at least one slot that extends from said interior surface and through said exterior surface, wherein said at least one slot is configured to receive said at least one extension portion therein such that said at least one extension portion extends radially outwardly from said exterior surface.

2. The load apparatus in accordance with claim 1, wherein said at least one coupling shaft end portion comprises a first coupling shaft end portion and a second coupling shaft end portion such that said first coupling shaft end portion is configured to couple to said at least one rotor shaft end portion and said second coupling shaft end portion is configured to couple to an end portion of a drive shaft.

3. The load apparatus in accordance with claim 1, wherein said main body portion comprises a channel defined therein such that said main body portion is substantially hollow.

4. The load apparatus in accordance with claim 1, wherein said main body portion comprises an interior portion that is substantially solid.

5. The load apparatus in accordance with claim 1, wherein said main body portion comprises a first diameter and said coupling shaft end portion comprises a second diameter.

6. The load apparatus in accordance with claim 5, wherein said first diameter is equal to said second diameter.

7. The load apparatus in accordance with claim 5, wherein said first diameter is not equal to said second diameter.

8. The load apparatus in accordance with claim 1, wherein said at least one slot comprises a first slot and a second slot, said first slot is configured to receive a first extension portion that extends radially outwardly from the surface of said device shaft end portion and said second slot is configured to receive a second extension portion that extends radially outwardly from the surface of said device shaft end portion such that each of the first and second extension portions extends radially outwardly from said exterior surface.

9. A power system comprising:
a machine comprising a drive shaft; and
a load apparatus coupled to said machine, wherein said load apparatus comprises:
a load configured to convert mechanical rotational energy to electrical energy for a power output;
a rotor assembly coupled to said load, wherein said rotor assembly comprises a rotor shaft comprising at least one rotor shaft end portion, said at least one rotor shaft end portion comprises at least one extension portion that extends radially outwardly from a surface of said at least one rotor shaft end portion; and
a coupling shaft configured to couple to said rotor shaft, wherein said coupling shaft comprises:
a cylindrical main body portion; and
at least one cylindrical coupling shaft end portion that extends from said main body portion, wherein said at least one coupling shaft end portion is configured to couple to said at least one rotor shaft end portion, said at least one coupling shaft end portion comprises:
an exterior surface;
an opposing interior surface; and
at least one slot that extends from said interior surface and through said exterior surface, wherein said at least one slot is configured to receive said at least one extension portion therein such that said at least one extension portion extends radially outwardly from said exterior surface.

10. The power system in accordance with claim 9, wherein said at least one coupling shaft end portion comprises a first coupling shaft end portion and a second coupling shaft end portion such that said first coupling shaft end portion is configured to couple to said at least one rotor shaft end portion and said second coupling shaft end portion is configured to couple to an end portion of said drive shaft.

11. The power system in accordance with claim 9, wherein said main body portion comprises a channel defined therein such that said main body portion is substantially hollow.

12. The power system in accordance with claim 9, wherein said main body portion comprises an interior portion that is substantially solid.

13. The power system in accordance with claim 9, wherein said main body portion comprises a first diameter and said coupling shaft end portion comprises a second diameter.

14. The power system in accordance with claim 13, wherein said first diameter is equal to said second diameter.

15. The power system in accordance with claim 13, wherein said first diameter is not equal to said second diameter.

16. The power system in accordance with claim 9, wherein said at least one slot comprises a first slot and a second slot, said first slot is configured to receive a first extension portion that extends radially outwardly from the surface of said device shaft end portion and said second slot is configured to receive a second extension portion that extends radially outwardly from the surface of said device shaft end portion such that each of the first and second extension portions extends radially outwardly from said exterior surface.

17. A method of using a load apparatus, said method comprising:
providing a load that is configured to convert mechanical rotational energy to electrical energy for a power output;
coupling a rotor assembly to the load, wherein the rotor assembly includes a rotor shaft including at least one rotor shaft end portion, the at least one rotor shaft end portion includes at least one extension portion that extends radially outwardly from a surface of the at least one rotor shaft end portion;
providing a coupling shaft that is configured to couple to the rotor shaft, wherein the coupling shaft includes a cylindrical main body portion and at least one cylindrical coupling shaft end portion that extends from the main body portion, the at least one coupling shaft end portion includes an exterior surface, an opposing interior surface, and at least one slot that extends from the interior surface and through the exterior surface; and
coupling the at least one coupling shaft end portion to the at least one rotor shaft end portion such that the at least one slot receives the at least one extension portion therein such that the at least one extension portion extends radially outwardly from the exterior surface.

18. The method in accordance with claim 17, wherein providing a coupling shaft comprises providing a coupling shaft that includes a first coupling shaft end portion and a second coupling shaft end portion such that the first coupling shaft end portion is configured to couple to the rotor shaft end portion and the second coupling shaft end portion is configured to couple to an end portion of a drive shaft.

19. The method in accordance with claim 17, wherein providing a coupling shaft comprises providing a coupling shaft that includes a main body portion that includes a channel defined therein such that the main body portion is substantially hollow.

20. The method in accordance with claim 17, wherein providing a coupling shaft comprises providing a coupling shaft that includes a main body portion that includes an interior portion that is substantially solid.

21. The method in accordance with claim 17, wherein providing a coupling shaft comprises providing a coupling shaft that includes a cylindrical main body portion that includes a first diameter and a cylindrical coupling shaft end portion that includes a second diameter.

22. The method in accordance with claim 21, wherein the first diameter is equal to the second diameter.

23. The method in accordance with claim 21, wherein the first diameter is not equal to the second diameter.

24. A load apparatus comprising:
a load configured to convert mechanical rotational energy to electrical energy for a power output;
a rotor assembly coupled to said load, wherein said rotor assembly comprises a rotor shaft comprising at least one rotor shaft end portion, said at least one rotor shaft end portion comprises at least one extension portion that extends outwardly from a surface of said at least one rotor shaft end portion; and
a coupling shaft configured to couple to said rotor shaft, wherein said coupling shaft comprises:
a cylindrical main body portion; and
at least one cylindrical coupling shaft end portion that extends from said main body portion, wherein said at least one coupling shaft end portion is configured to couple to said at least one rotor shaft end portion, said at least one coupling shaft end portion comprises:
an exterior surface;
an opposing interior surface; and
at least one slot that extends from said interior surface and to said exterior surface, wherein said at least one slot is configured to receive said at least one extension portion therein such that said at least one extension portion cannot extend through said exterior surface.

25. A load apparatus comprising:
a first shaft comprising at least one first shaft end portion, said at least one first shaft end portion comprises at least one extension portion that extends radially outwardly from a surface of said at least one first shaft end portion; and
a second shaft configured to couple to said first shaft, wherein said second shaft comprises a cylindrical portion that comprises at least one second shaft end portion, wherein said at least one second shaft end portion is configured to couple to said at least one first shaft end portion, said at least one second shaft end portion comprises:
an exterior surface;
an opposing interior surface; and
at least one slot that extends from said interior surface and through said exterior surface, wherein said at least one slot is configured to receive said at least one extension portion therein such that said at least one extension portion extends radially outwardly from said exterior surface.

26. A load apparatus comprising:
a first shaft comprising at least one first shaft end portion, said at least one first shaft end portion comprises at least one extension portion that extends radially outwardly from a surface of said at least one first shaft end portion; and
a second shaft configured to couple to said first shaft, wherein said second shaft comprises a cylindrical portion that comprises at least one second shaft end portion, wherein said at least one second shaft end portion is configured to couple to said at least one first shaft end portion, said at least one second shaft end portion comprises:
an exterior surface;
an opposing interior surface; and
at least one slot that extends from said interior surface and to said exterior surface, wherein said at least one slot is configured to receive said at least one extension portion therein such that said at least one extension portion cannot extend through said exterior surface.
